(19) United States
(12) Patent Application Publication
(10) Pub. No.: US 2018/0179023 A1
(43) Pub. Date: Jun. 28, 2018

(54) INCREASED TRACTION OF ELEVATOR SYSTEM BELT

(71) Applicant: Otis Elevator Company, Farmington, CT (US)

(72) Inventors: Pascal Rebillard, Gien (FR); Nicolas Fonteneau, Chateauneuf Sur Loire (FR); Emmanuel Convard, Gien (FR)

(21) Appl. No.: 15/739,255

(22) PCT Filed: Jun. 23, 2015
(86) PCT No.: PCT/IB2015/001250

§ 371 Date: Dec. 22, 2017

(51) Int. Cl. B66B 11/00; B66B 9/00; B66B 7/06; B66B 11/08

(52) U.S. Cl. CPC B66B 11/008; B66B 11/08; B66B 7/062; B66B 9/00

(57) ABSTRACT

An elevator system includes a hoistway and an elevator car (12) suspended in the hoistway via one or more suspension members (46). A counterweight (22) is suspended in the hoistway via the one or more suspension members (46) to balance operation of the elevator car (12). A traction sheave (24) is located in the hoistway to drive the one or more suspension members (46) along the hoistway via traction with frictional contact between the traction sheave (24) and the one or more suspension members (46), thus driving motion of the elevator car (12) and/or counterweight (22) along the hoistway. One or more diverters (66) are positioned in the hoistway in operable contact with the one or more diverters (66). The one or more diverters (46) are configured and positioned to define a wrap angle (68) of the one or more diverters (66) about the traction sheave (24); the wrap angle (68) being between 180 degrees and 360 degrees.

### BACKGROUND

The subject matter disclosed herein relates to elevator systems. More particularly, the present disclosure relates to increasing belt traction for traction elevator systems.

A typical elevator system includes an elevator car, suspended by one or more suspension members, typically a rope or belt, that moves along a hoistway. The suspension member is routed over one or more sheaves, with one sheave, also known as a drive sheave, operably connected to a machine. The machine drives movement of the elevator car via interaction of the drive sheave with the suspension member. The elevator system further typically includes a counterweight interactive with the suspension member, with a counterweight end of the suspension member terminated, or retained in the hoistway. Often, this termination is at a machine bedplate, a structural member extending across the hoistway. The counterweight is suspended in the hoistway via wrapping of the suspension member around a counterweight idler sheave connected to the counterweight, while the elevator car may be similarly suspended via wrapping of the suspension member around a car idler sheave connected to the elevator car.

Trends in elevator system design have led to significant weight reductions of mechanical structures of the elevator system, in particular the elevator car and elevator car frame. The elevator car weight reductions, however, may result in conditions where the suspension member has less than a desired amount of traction with the traction sheave, negatively affecting performance of the elevator system.

### BRIEF SUMMARY

In one embodiment, an elevator system includes a hoistway and an elevator car suspended in the hoistway via one or more suspension members. A counterweight is suspended in the hoistway via the one or more suspension members to balance operation of the elevator car. A traction sheave is located in the hoistway to drive the one or more suspension members along the hoistway via traction with frictional contact between the traction sheave and the one or more suspension members, thus driving motion of the elevator car and/or counterweight along the hoistway. One or more diverters are positioned in the hoistway in operable contact with the belt. The one or more diverters are configured and positioned to define a wrap angle of the belt about the traction sheave; the wrap angle being between 180 degrees and 360 degrees.

Additionally or alternatively, in this or other embodiments the one or more diverters include a diverter sheave having a circular cross-section.

Additionally or alternatively, in this or other embodiments the one or more suspension members are arranged in a 2:1 roping arrangement.

Additionally or alternatively, in this or other embodiments a machine is operably connected to the traction sheave to drive the traction sheave.

Additionally or alternatively, in this or other embodiments the one or more diverters are secured to a machine bedplate, supportive of the machine.

Additionally or alternatively, in this or other embodiments at least one of counterweight idler sheave and a car idler sheave are interactive with the one or more suspension members. The one or more diverters are positioned vertically between the traction sheave and one or each of the counterweight idler sheave and the car idler sheave.

Additionally or alternatively, in this or other embodiments the one or more diverters are located along the belt between the traction sheave and the counterweight.

Additionally or alternatively, in this or other embodiments a diverter radius horizontally overlaps a traction sheave radius.

Additionally or alternatively, in this or other embodiments the wrap angle is between 210 degrees and 360 degrees.

Additionally or alternatively, in this or other embodiments the one or more suspension members are one or more coated steel belts.

In another embodiment, a suspension member and sheave arrangement for a traction elevator system includes one or more suspension members supportive of one or more elevator system components, and a traction sheave to drive the one or more suspension members along the hoistway via frictional contact between the traction sheave and the one or more suspension members, thus driving motion of the one or more elevator system components. One or more diverters are in operable contact with the one or more suspension members. The one or more diverters are configured and positioned to define a wrap angle of the one or more suspension members about the traction sheave, the wrap angle being between 180 degrees and 360 degrees.

Additionally or alternatively, in this or other embodiments the one or more diverters include a diverter sheave having a circular cross-section.

Additionally or alternatively, in this or other embodiments the one or more suspension members are arranged in a 2:1 roping arrangement.

Additionally or alternatively, in this or other embodiments a machine is operably connected to the traction sheave to drive the traction sheave.

Additionally or alternatively, in this or other embodiments at least one of a counterweight idler sheave and a car idler sheave are located along the one or more suspension members, with the one or more diverters positioned along the one or more suspension members between the traction sheave and at least one of the counterweight idler sheave and the car idler sheave.

Additionally or alternatively, in this or other embodiments the one or more diverters are positioned vertically between the traction sheave and at least one of the counterweight idler sheave and the car idler sheave.

Additionally or alternatively, in this or other embodiments a diverter radius horizontally overlaps a traction sheave radius.

Additionally or alternatively, in this or other embodiments the wrap angle is between 210 degrees and 360 degrees.

Additionally or alternatively, in this or other embodiments the one or more suspension members are one or more coated steel belts.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an exemplary elevator system;

FIG. 2 is a cross-sectional view of an embodiment of a belt for an elevator system; and

FIG. 3 is a schematic view of a diverter arrangement for an elevator system.

The detailed description explains the invention, together with advantages and features, by way of examples with reference to the drawings.

### DETAILED DESCRIPTION

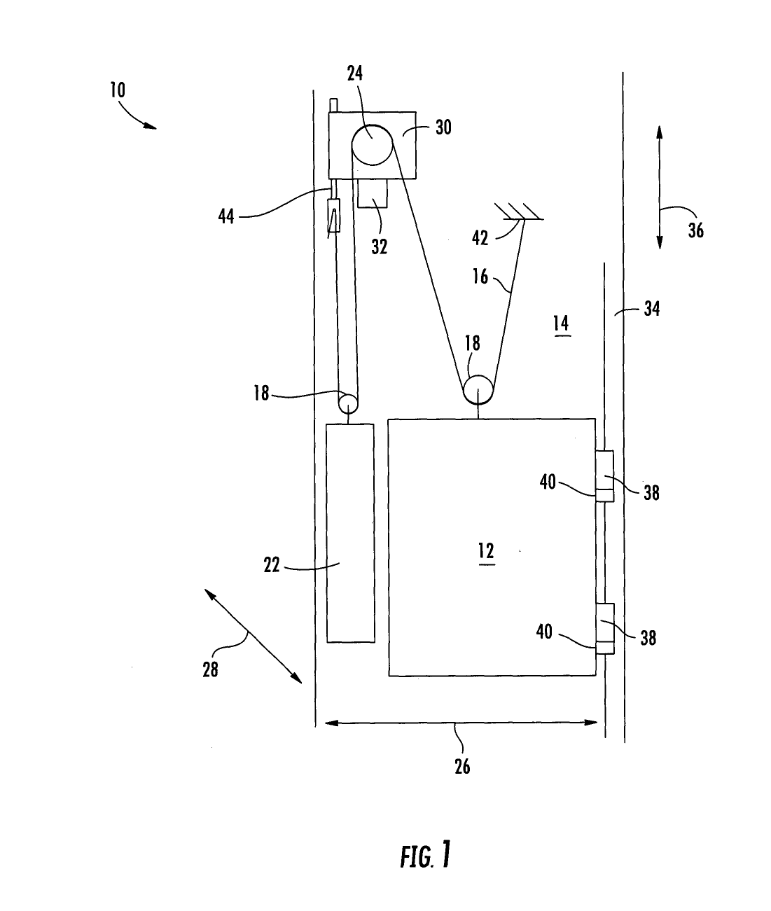

Shown in FIG. 1 is a schematic illustration of an exemplary elevator system 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more suspension members 16 are connected to a counterweight 22, which is used to help balance the elevator system 10 and reduce the difference in belt tension on both sides of a traction sheave 24 during operation. The hoistway 14 has a width 26 and a depth 28, and in some embodiments the counterweight 22 and elevator car 12 are positioned adjacently across the width 26 of the hoistway 14.

The sheaves 18 each have a diameter 20, which may be the same or different than the diameters of the other sheaves 18 in the elevator system 10. At least one of the sheaves is a traction sheave 24 driven by a machine 30. The machine 30 is disposed at and supported by a machine bedplate 32 extending across the hoistway 14 depth 28. Movement of traction sheave 24 by the machine 30 drives, moves and/or propels (through traction) the one or more suspension members 16 that are routed around the traction sheave 24. At least one of the sheaves 18 could be a diverter, deflector or idler sheave. Diverter, deflector or idler sheaves are not driven by the machine 30, but help guide the one or more suspension members 16 around the various components of the elevator system 10.

The elevator system 10 further includes one or more guide rails 34 to guide the elevator car 12 along a vertical length 36 of the hoistway 14. The elevator car 12 further includes one or more guide members, for example, guide shoes 38 interactive with the guide rails 34 to guide the elevator car 12, and also may include safeties 40 interactive with the guide rail 34 to slow and/or stop motion of the elevator car 12 under certain conditions, such as an overspeed condition.

While the elevator system 10 shown is a 2:1 roping arrangement, it is to be appreciated that elevator systems 10 with other roping arrangements, for example, 3:1 roping arrangements, are contemplated within the scope of the present disclosure. In the embodiment of FIG. 1, the suspension members 16 terminate in the hoistway 14 at a car end termination 42 nearest the elevator car 12 and at a counterweight end termination 44 nearest the counterweight 22.

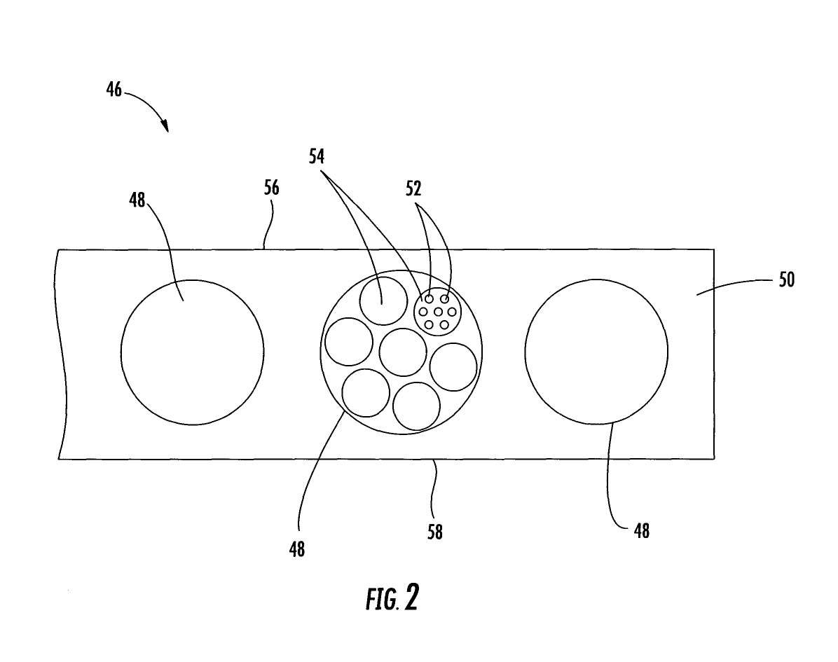

Referring to FIG. 2, in some embodiments the suspension member is a belt 46, for example, a coated steel belt 46. The belt 46 is constructed of one or more cords 48 in a jacket 50. The cords 48 of the belt 16 may all be identical, or some or all of the cords 48 used in the belt 46 could be different than the other cords 48. For example, one or more of the cords 48 could have a different construction, formed from different materials, or size than the other cords 48. As seen in FIG. 2, the belt 46 has an aspect ratio greater than one (i.e. belt width is greater than belt thickness). Each cord 48 comprises a plurality of wires 52, which in some embodiments are formed into strands 54, which are then formed into the cord 48.

The belt 46 is constructed to have sufficient flexibility when passing over the one or more sheaves 18 to provide low bending stresses, meet belt life requirements and have smooth operation, while being sufficiently strong to be capable of meeting strength requirements for suspending and/or driving the elevator car 12. The jacket 50 includes a traction portion 56 interactive with and contacting the drive sheave 24 and a back portion 58 opposite the traction portion 56. The jacket 50 is configured to substantially retain the cords 48 therein. The phrase “substantially retain” means that the jacket 50 has sufficient engagement with the cords 48 such that the cords 48 do not pull out of, detach from, and/or cut through the jacket 50 during the application on the belt 46 of a load that can be encountered during use in an elevator system 10. In other words, the cords 48 remain at their original positions relative to the jacket 50 during use in an elevator system 10. The jacket 50 could completely envelop the cords 48 (such as shown in FIG. 2), substantially envelop the cords 48, or at least partially envelop the cords 48. To meet the requirements for traction, cord 48 retention, wear resistance and others, the jacket 50 may be formed from a thermoplastic polyurethane (TPU) material. It is to be appreciated, however, that other materials may be utilized.

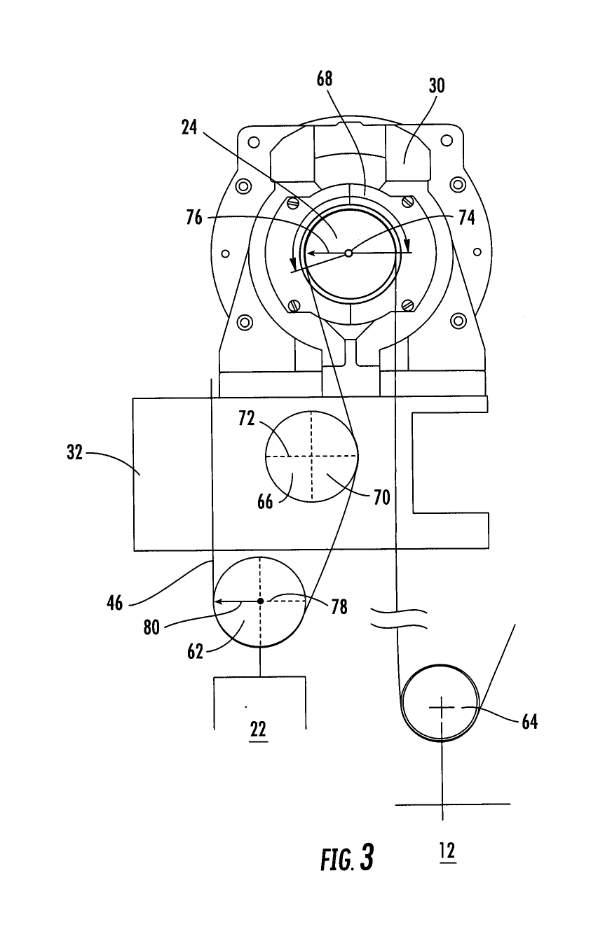

Referring now to FIG. 3, an exemplary elevator system arrangement is illustrated. The belt 46 has the counterweight end termination 44 at the machine bedplate 32 and extends around a counterweight idler sheave 62 connected to and supportive of the counterweight 22. The belt 46 wraps around the traction sheave 24 at the machine 30, then extends around a car idler sheave 64 connected to and supportive of the elevator car 12. It is to be appreciated that while a single counterweight idler sheave 62 and a single car idler sheave 64 are shown, multiple idler sheaves 62, 64 may be employed.

A diverter, for example a diverter sheave 66 is positioned along the belt 46 between the counterweight idler sheave 62 and the traction sheave 24 to increase a wrap angle 68 of the belt 46 around the traction sheave 24 to increase a traction between the traction sheave 24 and the belt 46. In some embodiments, the diverter sheave 66 is located at the machine bedplate 32.

The diverter sheave 66 has a diverter center 70 and diverter radius 72, while the traction sheave 24 similarly has a traction sheave center 74 and traction sheave radius 76 and the counterweight idler sheave 62 has a counterweight idler sheave center 78 and a counterweight idler sheave radius 80. To increase the wrap angle 68, the diverter sheave 66 is positioned with the diverter center 70 positioned horizontally between the counterweight idler sheave center 78 and the traction sheave center 74. Further, in some embodiments, the diverter sheave 66 is positioned such that the diverter radius 72 horizontally overlaps the traction sheave radius 76. Stated another way, when viewed from above, the traction sheave 24 projects onto the diverter sheave 66. Such positioning increases the wrap angle 68 beyond 180 degrees, to between 180 degrees and 360 degrees depending on the position of the diverter sheave 66. In some embodiments, a wrap angle 68 of about 210 degrees increases traction of the belt 46 around the traction sheave 24 to allow for significant weight decrease of the elevator car 12.

In another embodiment, a diverter sheave 66 is positioned along the belt 46 between the traction sheave 24 and the car idler sheave 64 to increase the wrap angle 68 of the belt 46 about the traction sheave 24. This diverter sheave 66 may also be used in combination with the diverter sheave 66 located along the belt 46 between the traction sheave 24 and the counterweight idler sheave 62. One skilled in the art will recognize that additional diverter sheaves 66 may also be utilized in addition to those described herein to increase the wrap angle 68.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. An elevator system comprising:
a hoistway;
an elevator car suspended in the hoistway via one or more suspension members;
a counterweight suspended in the hoistway via the one or more suspension members to balance operation of the elevator car;
a traction sheave located in the hoistway to drive the one or more suspension members along the hoistway via traction with frictional contact between the traction sheave and the one or more suspension members, thus driving motion of the elevator car and/or counterweight along the hoistway; and
one or more diverters disposed in the hoistway in operable contact with the belt, the one or more diverters configured and positioned to define a wrap angle of the belt about the traction sheave, the wrap angle being between 180 degrees and 360 degrees.

2. The elevator system of claim 1, wherein the one or more diverters include a diverter sheave having a circular cross-section.

3. The elevator system of claim 1, wherein the one or more suspension members are arranged in a 2:1 roping arrangement.

4. The elevator system of claim 1, further comprising a machine operably connected to the traction sheave to drive the traction sheave.

5. The elevator system of claim 4, wherein the one or more diverters are secured to a machine bedplate, supportive of the machine.

6. The elevator system of claim 1, further comprising at least one of counterweight idler sheave and a car idler sheave interactive with the one or more suspension members;
wherein the one or more diverters are positioned vertically between the traction sheave and one or each of the counterweight idler sheave and the car idler sheave.

7. The elevator system of claim 1, wherein the one or more diverters are disposed along the belt between the traction sheave and the counterweight.

8. The elevator system of claim 1, wherein a diverter radius horizontally overlaps a traction sheave radius.

9. The elevator system of claim 1, wherein the wrap angle is between 210 degrees and 360 degrees.

10. The elevator system of claim 1, wherein the one or more suspension members are one or more coated steel belts.

11. A suspension member and sheave arrangement for a traction elevator system comprising:
one or more suspension members supportive of one or more elevator system components;
a traction sheave to drive the one or more suspension members along the hoistway via frictional contact between the traction sheave and the one or more suspension members, thus driving motion of the one or more elevator system components; and
one or more diverters in operable contact with the one or more suspension members, the one or more diverters configured and positioned to define a wrap angle of the one or more suspension members about the traction sheave, the wrap angle being between 180 degrees and 360 degrees.

12. The suspension member and sheave arrangement of claim 11, wherein the one or more diverters include a diverter sheave having a circular cross-section.

13. The suspension member and sheave arrangement of claim 11, wherein the one or more suspension members are arranged in a 2:1 roping arrangement.

14. The suspension member and sheave arrangement of claim 11, further comprising a machine operably connected to the traction sheave to drive the traction sheave.

15. The suspension member and sheave arrangement of claim 11, further comprising at least one of a counterweight idler sheave and a car idler sheave disposed along the one or more suspension members, with the one or more diverters positioned along the one or more suspension members between the traction sheave and at least one of the counterweight idler sheave and the car idler sheave.

16. The suspension member and sheave arrangement of claim 15, wherein the one or more diverters are positioned vertically between the traction sheave and at least one of the counterweight idler sheave and the car idler sheave.

17. The suspension member and sheave arrangement of claim 11, wherein a diverter radius horizontally overlaps a traction sheave radius.

18. The suspension member and sheave arrangement of claim 11, wherein the wrap angle is between 210 degrees and 360 degrees.

19. The suspension member and sheave arrangement of claim 11, wherein the one or more suspension members are one or more coated steel belts.
